(19) United States
(12) Patent Application Publication
(10) Pub. No.: US 2023/0239392 A1
(43) Pub. Date: Jul. 27, 2023

(54) DETECTION OF SITUATIONS OF DIGITAL INAPTITUDE

(71) Applicant: Orange, Issy-Les-Moulineaux (FR)

(72) Inventors: Arnaud Brun, Chatillon Cedex (FR); Patrick Kirschbaum, Chatillon Cedex (FR)

(21) Appl. No.: 17/925,306

(22) PCT Filed: May 11, 2021
(86) PCT No.: PCT/FR2021/050810

§ 371 Date: Nov. 14, 2022

(30) Foreign Application Priority Data
May 14, 2020 (FR) 2004734

(51) Int. Cl. H04M 1/72454

(52) U.S. Cl. CPC H04M 1/72454; H04M 2250/56

(57) ABSTRACT

Detecting a user having a digital inaptitude (for example electronic illiteracy), where the user has at least one terminal and requires assistance suited for the use of at least one digital service from the terminal is disclosed. The following are provided: querying a database storing service-access requests from the terminal; among the requests, identifying at least incorrect requests relating to failed attempts by the user to access the service; estimating a frequency of incorrect requests for evaluating an electronic illiteracy score of the user; comparing the evaluated score to a preset threshold; and in case the evaluated score exceeds the threshold, detecting the user as having an electronic illiteracy in order to propose at last one specific surface suited to the user.

### CROSS-REFERENCE TO RELATED APPLICATIONS

This application is filed under 35 U.S.C. § 371 as the U.S. National Phase of Application No. PCT/FR2021/050810 entitled “DETECTION OF SITUATIONS OF DIGITAL INAPTITUDE” and filed May 11, 2021, and which claims priority to FR 2004734 filed May 14, 2020, each of which is incorporated by reference in its entirety.

### BACKGROUND

### Field

The present development relates to an application of telecommunication equipment for detecting user behaviors possibly representative of digital inaptitude.

### Description of the Related Technology

“Digital inaptitude” is a person's difficulty, or inability, to use digital equipment or computer tools. The person may for example encounter these difficulties (or inability) because of a lack or absence of knowledge about the operation thereof (sometimes called electronic or digital illiteracy), or because of a physical or intellectual handicap. For example, a person having the necessary skills for using computer may just the same find themselves in a situation of digital inaptitude because of a vision loss after an accident. A situation of digital inaptitude may also follow from using a device where a human-machine interface is defective (for example a phone with a cracked screen) and/or is too rudimentary.

Studies in 2019 showed that in France, 15% of people 15 or older had not used the Internet during the past year, while 38% of users lack at least one base digital skill and 2% have none at all. In total, electronic illiteracy affects 17% of the French population. This figure corresponds to the European average. For example, still according to these studies, 25% of the French population does not know how to get information using the Internet, and 20% is incapable of communicating through the Internet.

The people most affected by electronic illiteracy are in particular the oldest people, the less educated, and those having modest income. Electronic illiteracy may increase their social vulnerability. In fact, not knowing how to correctly access the Internet represents a real handicap, in particular for accessing public services and carrying out administrative tasks (reporting income, managing a bank account, etc.), finding training or employment, maintaining connections with friends or family or more generally their acquaintances, or simply purchasing a train ticket.

The fight against electronic illiteracy is a public policy issue comparable to fighting conventional illiteracy.

Telecommunication operators can play an important role in this fight, in particular by offering products and services dedicated to this fight.

### SUMMARY

There are solutions allowing users to measure and develop their digital skills, but there is not currently any solution allowing automatic detection of digital inaptitude situations.

The present patent application aims to at least partially improve this situation.

Thus, a first aspect of the present patent application relates to a method, executed in an electronic device, where said method comprises:
getting information representative of access requests to at least two services, made from at least one terminal, where said at least one terminal is associated with a first user login;
getting, from said representative information, an indicator about requests which, among said access requests, correspond to an access failure to at least one of said services;
triggering, as a function of said indicator and in combination with at least one of said terminals associated with said first user login, at least one action for assistance in using at least one of said services.

At least some of said services may in particular be digital services.

According to an embodiment, said indicator comprises a frequency of incorrect requests.

According to at least one embodiment, the process comprises:

among said access requests, identifying said incorrect requests.

According to at least one embodiment, identifying a incorrect request comprises:
verifying whether the length of an access to one of said services is shorter than a first length.

According to at least one embodiment, the process comprises:
querying a database storing requests from said at least one terminal for accessing one of said services.

According to an embodiment, the incorrect requests comprise at least one among the following requests:
at least one request for assistance accessing at least one of said services, made from the user's terminal;
at least one access request comprising an incorrect password, where the access request is an access request to at least one of said services from the terminal;
at least one access password reset request to at least one of said services made from the terminal;
at least one phone call made from the terminal;
at least one phone call made from the terminal to at least one voice assistance service about at least one of said services.

According to at least one embodiment, the indicator considers respective frequencies of incorrect requests to said services.

According to another aspect, the present patent application relates to a method, executed on a terminal of a communication network, comprising:
sending on said communication network at least one first access request to at least one first service among a plurality of services;
upon receiving from said communication network a signal depending on failures of requests for access to at least two services from said plurality of services, where said requests are made from a terminal of said communication network associated with said user login, executing an action for assistance using at least one second service from said terminal.

The characteristics, presented in isolation in the present application connected with some embodiments of one of the methods from the present application, may be combined with each other according to other embodiments of these methods.

For example, the present application relates to a method for detection of digital inaptitude, like electronic illiteracy, of at least one user having at least one terminal, where the process comprises:
statistically analyzing incorrect requests among requests coming from the terminal for access to at least one service, where an incorrect request is a request for which access to the service failed, where detection of digital inaptitude, like electronic illiteracy, is a function of the results of the analysis.

Thus, such an implementation may help to detect a situation of digital inaptitude of at least one user, like electronic illiteracy, without disrupting the user in their interaction with the terminal.

The statistical analysis mentioned above can be done for example by studying the history of requests (by means of a database, for example), or even in real time, as requests are received the terminal.

Thus, in an implementation, the statistical analysis may comprise:
estimating a frequency of incorrect requests.

The frequency of incorrect requests, mentioned above, may be estimated by a percentage of incorrect requests relative to a set of requests over a time period, for example a preset time period (for example, monthly or other).

In an implementation, the process may further comprise:
among said requests, identifying at least some incorrect requests relating to failed service-access attempts by the user.

For example, identifying a incorrect request may comprise:

verifying whether the length of an access to a service is shorter than a threshold.

The access may in particular be a phone call, in which case, for example, the call made, for a length shorter than the aforementioned threshold, was an incorrect call.

In an implementation, the process may comprise:

querying a database storing service-access requests from the terminal.

In an implementation, the process may comprise:
verifying whether the results of the analysis exceed a first threshold value (like a preset threshold obtained for example from a configuration file), where a verified overrun corresponds to detecting a digital inaptitude, like electronic illiteracy of the user.

Thus, such an implementation may help detect a digital inaptitude situation of at least one user, having at least one terminal, for example at least one user with electronic illiteracy, where this digital inaptitude situation can for example require a suitable assistance for the user in order to use at least one digital service from the terminal. In a sample implementation, the process may comprise:
querying a database storing service-access requests from the terminal;
among said requests, identifying at least incorrect requests relating to failed attempts by the user to access the service;
estimating a frequency of incorrect requests for evaluating a digital inaptitude score, like electronic illiteracy of the user;
comparing the evaluated score to a preset threshold; and
in case the evaluated score exceeds the threshold, detecting the user as having a digital inaptitude, like an electronic illiteracy; in order to propose at last one specific surface suited to the user.

The aforementioned specific service may be the same kind as the digital service that the user seeks to use from their terminal, but in a modified form, in order to be suitable to the user for example. As a variant, it may involve a different service, such as a tutorial, for example or other.

Thus, some embodiments propose actively detecting users potentially having digital inaptitude, such as electronic illiteracy, and thereafter propose adapted user interfaces or specific training which could be adapted to their level of digital inaptitude (electronic illiteracy or handicap for example). Thus, such an implementation may contribute to fighting digital isolation.

In an embodiment, the aforementioned incorrect requests may comprise at least some requests for assistance accessing the digital service, made from the users terminal.

Thus, the aforementioned incorrect requests characterize a failure situation for the user using the digital service.

For example, in an implementation where the aforementioned database stores telephone call record data for the terminal, the incorrect requests for the user may typically comprise assistance requests and call record data may comprise identifiers of calls to at least one voice assistance service for guiding the user in the use the digital service.

In that way, telephone calls to the voice assistant service may be identified in the call records and characterize a incorrect request from the user.

In addition, or as a variant, in an implementation where the database stores telephone call record data for the terminal, and also call lengths in the call record data, the method may further comprise:
identifying in the database call occurrences with lengths shorter than a threshold, as call attempts to incorrect numbers;
and counting said occurrences for estimating the digital inaptitude score (electronic illiteracy or handicap for example) of the user.

In that way calls to incorrect numbers can be identified as field requests.

Again in addition or as a variant, the service may be digital and digital may be accessible by means of entering a login and password, and the database then stores at least one of the occurrences relating to incorrect login and password entry attempts, as incorrect requests.

In a specific embodiment where the digital service is accessible by means of entering a login and password, the aforementioned database may store in particular password reset requests made from the user's terminal, as incorrect requests. It may further store requests for login retrieval (“forgotten login”) sent by the user, since these requests may also be considered as incorrect requests.

In an implementation, the aforementioned incorrect requests comprise at least one request among the following requests:
least one request for assistance accessing the digital service, made from the user's terminal;
at least one access request comprising an incorrect password, where the access request is an access request to the service from the terminal;
at least one access password reset request to the service made from the terminal;
at least one phone call made from the terminal;
at least one phone call made from the terminal to at least one voice assistance service about the digital service.

In an implementation where the requests are sent to a plurality of distinct service providers for a plurality of respective services, the aforementioned score may be evaluated by a weighted sum of respective frequency estimates for incorrect requests sent to these distinct service providers.

In such an implementation where the distinct service providers comprise for example two service providers, the aforementioned score may be evaluated by a relation like this:

$$S ( u ) = ( 1 - P ) * ( \frac{{N}_{D e t e c {t}_{1}} ( u )}{{N}_{{Total}_{1}} ( u )} * 100 ) + ( P ) * ( \frac{{N}_{D e t e c {t}_{2}} ( u )}{{N}_{{Total}_{2}} ( u )} * 100 )$$

where:
u is a user login;
S(u), the score of the evaluated user;
N_{Detect}_{₁}(u), a number of incorrect requests to a first service provider, among the plurality of distinct service providers, made from the terminal of the user with login u;
N_{Total}_{₁}(u), a total number of service requests to the first service provider, made from the terminal of the user with login u;
N_{Detect}_{₂}(u), a number of incorrect requests to a second service provider, among the plurality of distinct service providers, made from the terminal of the user with login u;
N_{Total}_{₂}(u), a total number of service requests to the second service provider, made from the terminal of the user with login u;
P, a weighting coefficient included between 0 and 1.

For example, here the first service provider may be for example a telecommunication operator using a first server storing call record (CRA) data, while the second service provider may use a server storing requests sent over the Internet (HTTP or other type) from the user's terminal.

The development also targets the computer program comprising instructions for implementing at least one of the above methods, when these instructions are executed by a processor, for example a processor for a processing circuit. A general algorithm example for this program is shown in FIG. 2 discussed later. The instructions for the computer program may be stored and executed on a user's terminal, or else on a platform for detection of digital inaptitude, like electronic illiteracy, or even distributed between the user's terminal and the platform, where these entities are covered later.

According to at least one embodiment, the computer program for example comprises instructions for executing a method executed in an electronic device, where said method comprises:
getting information representative of access requests to at least two services, made from at least one terminal, where said at least one terminal is associated with a first user login;
getting, from said representative information, an indicator about requests which, among said access requests, correspond to an access failure to at least one of said services;
triggering, as a function of said indicator and in combination with at least one of said terminals associated with said first user login, at least one action for assistance in using at least one of said services.

According to at least one embodiment, computer program for example comprises instructions for executing a method executed on a terminal of a communication network, comprising:
sending on said communication network at least one first access request to at least one first service among a plurality of services;
upon receiving from said communication network a signal depending on failures of requests for access to at least two services from said plurality of services, where said requests are made from a terminal of said communication network associated with said user login, executing an action for assistance using at least one second service from said terminal.

According to another aspect, the present application relates to an electronic device comprising at least one processor configured for:
getting information representative of access requests to at least two services, made from at least one terminal, where said at least one terminal is associated with a first user login;
getting, from said representative information, an indicator about requests which, among said access requests, correspond to an access failure to at least one of said services;
triggering, as a function of said indicator and in combination with at least one of said terminals associated with said first user login, at least one action for assistance in using at least one of said services.

According to at least one embodiment, triggering comprises execution of said assistance action from said electronic device.

According to at least one embodiment, triggering comprises transmission of an execution command from said assistance action to at least one of said at least one terminal.

According to at least one embodiment, said electronic device is one of said at least one terminal and or one service platform.

The characteristics, presented in isolation in the present application connected with some embodiments of a device according to the present application may be combined with each other according to other embodiments of this device.

Thus, in some embodiments, the present development also targets a platform for detection of a digital inaptitude, like electronic illiteracy, for at least one user having at least one terminal, where the platform comprises.
a communication interface with at least one terminal of the user, where the communication interface comprises a receiver for access request to a service of the terminal and a sender of access to the service to the terminal;
a statistical analyzer (which may have the form of a processor PROC2 interacting with memory MEM2, as shown in FIG. 4 discussed later) for incorrect requests among requests coming from the terminal for access to at least one service, where one incorrect request is a request for which access to the service failed, where detection of digital inaptitude, like electronic illiteracy, is a function of the results of the analysis.

In an embodiment, this platform may comprise an interface (distinct from, or identical to, the aforementioned communication interface) for communication with at least one database storing at least one of the requests for access to the service, where the interface comprises a receiver of data from the database.

In an embodiment, the service platform comprises an assistant triggered by the statistical analyzer depending on the analysis resolved, where the assistant provides assistance suited for the use of at least one digital service from the terminal.

As previously indicated, the tutorial may be offered to the user for familiarizing them with the use of digital services. As a variant, a specific service may be offered, of the same kind as the digital service that the user seeks to use from their terminal, but in a simplified form in order to be suited to the difficulties that the user encounters, for example.

For example, the user's terminal may offer the user thereof an interactive menu that is simplified and suited to the user.

Further, according to another aspect the present patent application relates to a terminal (TER) associated with at least one user login and comprising at least one processor configured for:
sending on a communication network at least one first access request to at least one first service among a plurality of services;
upon receiving from said communication network a signal depending on failures of requests for access to at least two services from said plurality of services, where said requests are made from a terminal of said communication network associated with said user login, executing an action for assistance using at least one second service from said terminal.

According to at least one embodiment, said terminal comprises a human-machine interface (HMI), where the human-machine interface is configured for being driven by a simplified user menu for said second-service services, as a function of said signal.

The characteristics, presented in isolation in the present application connected with some embodiments of a terminal or a device according to the present application, may be combined with each other according to other embodiments of this terminal or device.

Thus, some embodiments of the present development target a terminal comprising:
a communication interface with at least one service provider, where the communication interface comprises a sender for access request to a service of the terminal and a receiver of access to the service to the terminal;
the communication interface comprises a receiver of a signal as a function of a result provided by a statistical analyzer of incorrect requests among requests coming from the terminal for access to at least one service, where one incorrect request is a request for which access to the service failed, where detection of digital inaptitude, like electronic illiteracy, is a function of the results of the analysis.

The aforementioned supplied result may simply be a digital inaptitude (electronic illiteracy or handicap, for example) score indicator, or even a link to a server better suited to the user based on their detected digital inaptitude, or other.

The aforementioned signal may be a simple message in particular for indicating the level of digital inaptitude (electronic illiteracy or handicap for example) of the user (for example a single indication signal or an information signal), or even a training advice message, or message containing a link to a suitable server, or command executing the access to a better suited server providing the same service but with a simplified human-machine interface for the user, or even a signal (typically an adaptation signal) transporting data in the particular data from a simplified menu intended to be executed by the human-machine interface of the terminal.

In an implementation, the terminal comprises a human-machine interface, configured for being driven by a simplified user menu for the digital service, based on information about detecting a digital inaptitude (like electronic illiteracy or a handicap) received in the signal.

Thus, for example, in case the evaluated score exceeds the threshold, the terminal may execute a routine for driving the human-machine interface with a user manual for the digital service, simplified for the user (for example with simple headings, selected for the user and made colloquial).

### BRIEF DESCRIPTION OF THE DRAWINGS

Other advantages and characteristics of the development will appear upon reading the following detailed description of implementation examples, and on examining the attached drawings, on which:

FIG. 1 schematically shows in particular a platform F, in operation for executing at least some embodiments of the development.

FIG. 2 shows the main steps of a method according to at least some embodiments of the development.

FIG. 3 schematically shows the processing circuit of a terminal according to at least some embodiments of the development.

FIG. 4 shows schematically the processing circuit for a platform according to at least some embodiments of the development.

### DETAILED DESCRIPTION OF CERTAIN ILLUSTRATIVE EMBODIMENTS

Below, examples are given for illustration of typical behaviors of users suffering from digital inaptitude, like electronic illiteracy or a physical or mental handicap. These people may encounter problems such as:
Difficulties accessing an Internet site, for example a site giving today's weather;
Difficulties entering a login and a password, for example for accessing a personal space;
Difficulties dialing a phone number (by using a phone keypad or touch screen of a mobile phone), for example for calling a contact, an emergency number or a client service;
Etc.

A solution is proposed below allowing:
Automatically detecting users potentially having digital inaptitude, like electronic illiteracy;
Making specific services available to them to make it easier for them to use digital tools (for example, phone, Internet access, etc.).

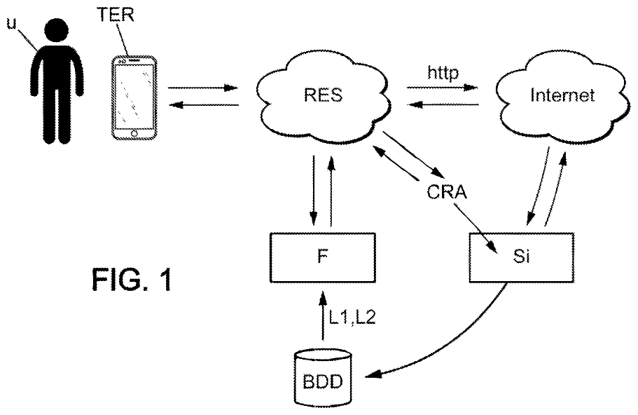

For this purpose, a platform F is provided (FIG. 1; which may have the material form of a server, for example), capable of making use of several data sources in order to automatically detect behaviors which might be observed more frequently in people having a digital inaptitude, like electronic illiteracy. Examples of such behaviors are calls to tech support, or requests for password reset following several incorrect password entries, or even requests for resetting logins (typical case where the user forgets their login and request that it be sent to them, by email for example), etc.

In that way it is possible to identify users for whom this type of behavior is abnormally high (meaning, for example, much higher than the observed average in the entire population of users of the same network). In that way, the user who occasionally calls on technical support or who asks for resetting of one of their passwords every so often is not detected as potentially having a digital inaptitude, like electronic illiteracy. In contrast, a user who makes use of technical support very often and who asks for resetting of the password nearly every time they attempt to connect to a personal space may be detected as potentially having a digital inaptitude, like electronic illiteracy.

In the example described below, two data sources may thus be used by the platform F:
call records (CRA);
Internet navigation information.

Use of these two data sources by the platform F is described below.

Referring to FIG. 1, a user's terminal TER is connected by a network RES to a platform F which is connected to a computer system SI of a telecommunication operator, in particular to the part of the computer system in which the call records (CRA) are generated. The CRA are digital data which are generated automatically in the telecommunication operators' computer systems (fixed and mobile) during each phone call (from a landline or mobile phone). These CRA are used by the operators in particular for billing the clients thereof and generating detailed bills for clients thereof: they therefore generally contain information about each phone call made and received by the users of the network RES:
the phone number of the caller: in the case of a mobile phone (GSM, UMTS, etc.), this number is for example MSISDN type (Mobil Station ISDN Number, ISDN for Integrated Services Digital Network);
the called telephone number;
the time of the call;
the call duration;
Etc.

The format of these CRA is not standardized (each telecommunications operator generally uses their own CRA format).

The platform F is capable of querying, for example regularly, the computer system (SI) of the operator in order to retrieve the CRA generated since the last query. Typically, retrieving the CRA may be done daily (typically each night).

When new CRA are retrieved this way (for example upon retrieval), the platform F analyzes them in order to detect some specific calls made (for example, calls to numbers corresponding to technical support, typically).

Calling L1 the list of the specific numbers (or specific prefixes of numbers) which are thus detected by F (this list can be modified by the operator at any time), L1 is stored in a database (BDD) near the platform F. This list L1 therefore contains phone numbers (for example: +33810 20 20 00, +33810 30 30 30, etc.) and also prefixes of phone numbers (for example: +33810*, +33820*, etc.) characterizing user assistance requests to dedicated services.

A user who calls this type of number identified as being technical support numbers very frequently (meaning many more times than average for users of this same network) is in fact considered to be a user likely to encounter difficulties more often when using their digital tools (phone, Internet access, etc.).

Further, when new CRA are retrieved, the platform F also identifies the CRA corresponding to abnormally short calls (typically a length of a few seconds). A user who very frequently (meaning many more times than average for users of this network) makes very short calls is considered to be a user who could frequently dial wrong numbers (meaning that they often make an entry error when dialing a phone number and thus calls another user than whom they intended; in this case the communication is obviously very short).

Further, the platform F is also capable of querying the computer system (IS) of the operator in order to retrieve, for example regularly, each day for example (typically, each night), the Internet navigation information about users of the network of the operator.

In fact, for example from a mobile phone (via any mobile network, for example: GSM, UMTS, LTE, etc.) or a computer (for any type of technology used, for example ADSL, optical fiber or other), when a user accesses an Internet page (for example the portal of the operator), a trace may be generated automatically in the computer system SI of the operator. This trace may in particular contain an identifier, unique for example, of the user (for example their IMSI identifier if the user accesses the Internet from a mobile phone). Recall that the IMSI identifier (for International Mobile Subscriber Identity) is a unique number which allows a mobile phone network (GSM, UMTS, LTE or other type) to identify a user. This number is stored in the SIM card (or USIM in UMTS or LTE) it is not known to the user.

In principle, if the user potentially has a digital inaptitude, they are unlikely to use a device to anonymously access the Internet, meaning without generating traces with which to identify them on the operator's network. If a user is capable of traveling the Internet anonymously, they cannot really be considered as subject to a digital inaptitude, like electronic illiteracy.

When new navigation information is retrieved that way, the platform F analyzes it in order to detect some behaviors, in particular accessing pages for access to personal environments requiring entry of a login and password by the user.

The user who accesses the same page for access to a personal environment several times in a limited span (five times in a row over several minutes) is considered as having difficulties logging in (because they forgot their login or password, or else because they could not enter them correctly, or even simply because they do not know how to enter a login and password, or other difficulties). Below, the more a user shows this type of behavior, the more it is considered that they potentially have a digital inaptitude, like electronic illiteracy.

Likewise, the platform F analyzes navigation information relating to access to pages corresponding the password reset requests (case where the user forgot their password) or request for login retrieval (case where the user forgot their login, or simply don't know what it is).

The addresses of these various Internet pages are stored in a list L2, itself stored in the database (BDD) of the platform F. This list L2 can be modified at any time by the operator.

Additionally, the platform F is also capable of detecting access to specific Internet pages (corresponding to access to personal environments, to a request for resetting the password or even to requesting a login, etc.) by looking for the presence of keywords in the address of the Internet pages consulted. Thus, for example, the following keywords may be used for this search in the addresses of Internet pages consulted: “login,” “account,” “reset,” etc. The addresses of the Internet pages may be materialized by character strings such as for example URL (Uniform Resource Locator) links, or even HTTP (HyperText Transfer Protocol), or others, in which it is possible to look for a correspondence with preset keywords.

All these keywords are stored in the list L2. An address containing the keyword “login” is considered to most often correspond to the access to a personal environment, or an address containing the keyword “reset” is considered to most often correspond to a request for resetting a password, etc. There again, the more a given user consults Internet pages having addresses containing this type of keyword, the more this user is considered as potentially having digital inaptitude.

Hereafter, the calculation of the score characterizing whether the user is potentially suffering from a digital inaptitude, like electronic illiteracy, is described.

The score characterizing the probability that a given user has digital inaptitude, like electronic illiteracy is referenced as S (a score S is assigned to each user of the network of the operator). The scores of the set of network users are stored in the database BDD of the platform F.

The score S is for example a percentage:
the minimum score (0%) corresponds to a user for whom no observed behavior corresponds to one of the behaviors frequently observed in people having a digital inaptitude, like electronic illiteracy;
the maximum score (100%) corresponds to a user for whom all observed behaviors correspond to one of the behaviors frequently observed in people having a digital inaptitude, like electronic illiteracy.

Calculation of the score S may be done automatically by the platform F, and may be updated (recalculated) automatically, after use of new data recovered in the computer system SI (CRA and/or Internet navigation information), typically daily (each night for example).

The value of the score S is calculated by the platform F, for example according to a predetermined formula (set by the operator, for example; this formula is for example stored in a database on the platform F and it can be modified at any time, for example by the operator).

In the following, note:
u, a login of one of the users of the operator;
S(u), the score of the user u (i.e. characterizing whether the user u does or does not have a digital inaptitude, like numerical illiteracy);
N_{Detect}_{₁}₍ᵤ₎, the number of behaviors detected in the first data source (the call records for example) for the user u (behaviors considered as typical of people with digital inaptitude, like electronic illiteracy);
N_{Total}_{₁}₍ᵤ₎, the total number of behaviors analyzed in the first data source (call records, in this example) for the user u;
N_{Detect}_{₂}₍ᵤ₎, the number of behaviors detected, for example, in the second data source (the Internet navigation information) for the user u (behaviors considered as typical of people with digital inaptitude, like electronic illiteracy);
N_{Total}_{₂}₍ᵤ₎, the total number of behaviors analyzed in the second data source (Internet navigation information) for the user u.

For example, the score S(u) of the user u may be calculated according to the following formula:

$$S ( u ) = \frac{( \frac{{N}_{D e t e c {t}_{1}} ( u )}{{N}_{{Total}_{1}} ( u )} * 100 ) + ( \frac{{N}_{D e t e c {t}_{2}} ( u )}{{N}_{{Total}_{2}} ( u )} * 100 )}{2}$$

The value the denominator corresponds to the number of data sources (which in this example is two).

In a possible variant of the development, this formula used for the calculation of the score S(u) contains a weight (P) with which to give more or less importance to one or another of the two data sources.

P is a decimal number with a value included between 0 and 1.

In this case, the score S(u) may be calculated according to the following formula:

$$S ( u ) = ( 1 - P ) * ( \frac{{N}_{D e t e c {t}_{1}} ( u )}{{N}_{{Total}_{1}} ( u )} * 100 ) + ( P ) * ( \frac{{N}_{D e t e c {t}_{2}} ( u )}{{N}_{{Total}_{2}} ( u )} * 100 )$$

For example, P=0.25 gives more weight to the detection by the CRA in this example.

Next, the score S(u) may be used by the platform as follows.

It may set a threshold (configurable) above which a user u is considered as potentially having a digital inaptitude, like electronic illiteracy. The value of this threshold may be set for example between 10% and 50%, for example 20%.

If the value of S(u) is less than this threshold, the user u is not considered as having a digital inaptitude, like electronic illiteracy. Inversely, if the value of S(u) is greater than this threshold, the user u is considered as having a digital inaptitude.

When a user u is considered as having a digital inaptitude, like electronic illiteracy, some specific services are proposed, for example:
Phone access to a personal assistant specialized in helping people with a digital inaptitude, like electronic illiteracy, cataloged as such in a database;
Access to online training or tutorials serving to combat digital inaptitude, like electronic illiteracy;
Etc.

Further, when a user u is considered as having a digital inaptitude, like electronic illiteracy, some services provided by the operator may be adapted in order to make the use thereof easier.

The installation of applications on terminals of these users may be provided for in order to change the execution of the human-machine interfaces these terminals in order to simplify the messages from these interfaces.

The modification of the human-machine interface may be programmed in order for simplification of the login/password entry procedure, for example for the connection to a personal space provided by the operator (password entered by the user may for example be displayed in the clear during entry thereof, meaning that is not replaced by a succession of “*” characters during entry thereof, thus limiting the risks of incorrect entry).

Further, the simplification of the human-machine interface, for example of the operator portal, can be provided. In this case, a request made from the terminal calls for the presentation of a more basic homepage, limiting base functionalities, possibly without advertisement bands, and the display of a contact point for technical support clearly visible at any time, etc.

Further, automatic access to a specific technical support dedicated to people with digital inaptitude, like electronic illiteracy, can be provided. When the user calls client service of the operator, the user is directed (based on the coordinates of their terminal for example) to a person having experience providing support to people with digital inaptitude or an electronic illiteracy.

At any time, a user may contact the operator (by simple telephone call for example) activating or deactivating the automatic calculation of their S(u) score.

At any time, a user may contact the operator (by a simple phone call for example) for requesting the operator to eliminate all data about them present in the database of the platform F (BDD database).

Thus, a service can be implemented for detection of users having digital inaptitude, like electronic illiteracy, in order to offer them specific and adapted services. The use of digital tools thus makes fighting against digital inaptitude, like electronic illiteracy, easier and supports digital inclusion.

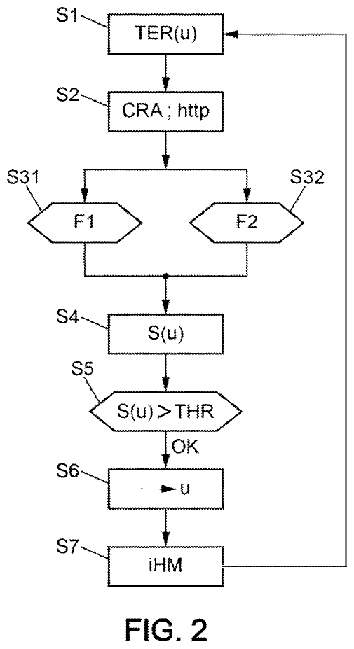

In FIG. 2 the steps of a process according to a possible embodiment are summarized. During the first step S1, a terminal of the user u makes phone calls and/or requests over the Internet. At step S2, the computer system SI of the telecommunications operator collects, the call record CRA and the requests made from the terminal TER in order to feed the database BDD. At step S31, based on the call records CRA, a frequency f1 of calls to a number specifically for assistance with the use of the digital services (online help platforms, etc.) may be estimated. This frequency f1 can be estimated for example as the ratio between the number of calls to assistance platforms and the total number of calls, as previously presented, or again f1 may be estimated according to the number of calls to assistance platforms per unit time (for example per day, per week or per month), or again the aforementioned ratio may be determined for such a time unit. At step S32, a frequency f2, for example of incorrect requests through the Internet and coming from the terminal TER, or even password reset requests (requests identified by the term “reset,” “logon,” etc.) may further be estimated. As with the frequency f1, the frequency f2 may be estimated by a ratio of the number of incorrect requests (incorrect or requesting a password or other) over a total number of requests, and/or over a preset time period.

In step S4, the score S(u) for the user u may be calculated, as a weighted sum for example of the frequencies f1, f2, for example of the type:
S(u)=(1−P) f1+Pf2, as previously presented. In step S5, if the score exceeds a threshold value THR, for example a preset threshold value (arrow OK at output from test S5), for example 20%, then in step S6, the user u of the terminal is considered as suffering from a digital inaptitude, like electronic illiteracy. In this case, the presentation of specific services for the user u, for example a tutorial or equivalent, or even the execution of a routine on the terminal TER in order to drive a human-machine interface (step S7) with a simpler menu for using the digital service requested by the user (with fewer headings for example and only keeping essential headings for the user possibly with simplified training for these headings for the user) may be provided.

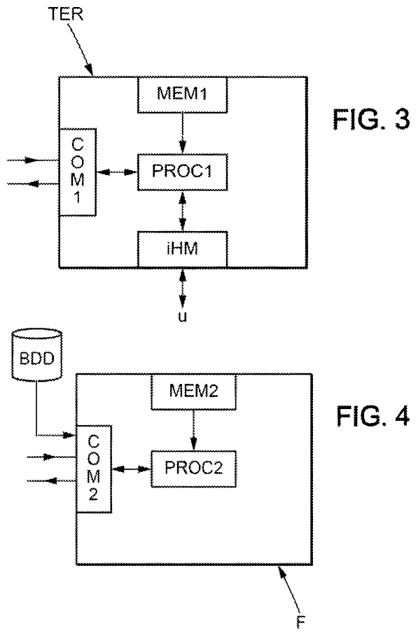

For that purpose, a terminal TER for executing such an implementation may comprise, as shown in FIG. 3, a processing circuit comprising at least:
a communication interface COM1 with the network RES of the operator;
a processor PROC1 connected to the interface COM1 for processing in particular data received from the platform F according to which the user u of the terminal TER potentially has a digital inaptitude, like electronic illiteracy, and executing a routine as a consequence for driving the human-machine interface according to a simplified mode;
a memory MEM1 connected to the processor PROC1 for storing at least the instructions for the aforementioned routine; and
the human-machine interface HMI (for example a touch screen displaying headings for use of a digital service) for example for offering the user u a simplified navigation menu for use of the requested digital service.

In some embodiments, the processor PROC1 may be configured for:
sending on a communication network at least one first access request to at least one first service among a plurality of services;
upon receiving from said communication network a signal depending on failures of requests for access to at least two services from said plurality of services, where said requests are made from a terminal of said communication network associated with a user login associated with the terminal TER, executing an action for assistance using at least one second service from said terminal.

The platform F further comprises its own processing circuit, comprising at least:
a communication interface COM2 with the network RES of the operator, and also data coming from the database BDD;
a processor PROC2 for executing a computer program in the meaning of the present development for executing the process according for example to the embodiment shown in FIG. 2; and
a memory MEM2 accessible to the processor PROC2 and storing in particular instructions for the aforementioned computer program.

In some embodiments, the processor PROC2 may be configured for:
getting information representative of access requests to at least two services, made from at least one terminal, where said at least one terminal is associated with a first user login;
getting, from said representative information, an indicator about requests which, among said access requests, correspond to an access failure to at least one of said services;
triggering, as a function of said indicator and in combination with at least one of said terminals associated with said first user login, at least one action for assistance in using at least one of said services.

1. A process, executed in an electronic device, the process comprising:
getting information representative of requests about at least two services, made from at least one terminal, where the at least one terminal is associated with a first user login;
getting, from the representative information, an indicator about first requests which, among the requests about the at least two services, correspond to an access failure to at least one of the services, to request for assistance about at least one of the services and/or entry errors for a recipient of a communication; and
triggering, as a function of the indicator and in combination with at least one of the terminals associated with the first user login, at least one action for assistance.

2. The process according to claim 1, wherein the indicator comprises a frequency of incorrect requests.

3. The process according to claim 1, wherein the process comprises:
among the requests about at least two services, identifying the first requests.

4. The process according to claim 3, wherein identifying an incorrect request comprises:
verifying whether the length of an access to one of the services is shorter than a first length.

5. The process according to claim 1, wherein the process comprises:
querying a database storing requests from the at least one terminal for accessing one of the services.

6. The process according to claim 1, wherein the first requests comprise at least one among the following requests:
at least one request for assistance accessing at least one of the services, made from the user's terminal;
at least one access request to at least one of the services from the terminal, comprising an incorrect password;
at least one access password reset request to at least one of the services made from the terminal;
at least one phone call made from the terminal;
at least one phone call made from the terminal to at least one voice assistance service about at least one of the services.

7. The process according to claim 6, wherein the indicator considers respective frequencies of first requests to the services.

8. An electronic device comprising at least one processor configured for
executing a process according to claim 1.

9. The electronic device according to claim 8, wherein the electronic device is one of the at least one terminal and or one service platform.

10. The electronic device according to claim 8, wherein triggering comprises execution of the assistance action from the electronic device.

11. The electronic device according to claim 8, wherein triggering comprises transmission of an execution command from the assistance action to at least one of the at least one terminal.

12. A process, executed in a terminal on communication network, comprising:
sending on the communication network at least one first request about at least one first service among a plurality of services; and
upon receiving from the communication network a signal depending on requests made from a terminal of the communication network associated with the user login, and about at least two services from the plurality of services corresponding to an access failure to at least one of the two services and/or entry errors for a recipient of a communication, executing at least one action for assistance from the terminal.

13. A terminal associated with at least one user login and comprising at least one processor configured for:
sending on a communication network at least one first access request to at least one first service among a plurality of services; and
upon receiving from the communication network a signal depending on requests made from a terminal of the communication network associated with the user login, and about at least two services from the plurality of services, corresponding to an access failure to at least one of the two services and/or entry errors for a recipient of a communication, executing at least one action for assistance from the terminal.

14. The terminal according to claim 13, where the terminal comprises a human-machine interface, where the human-machine interface is configured for being driven by a simplified user menu for the second-service services, as a function of the signal.

15. A processing circuit comprising a processor and a memory, the memory storing program code instructions of a computer program for executing the process according to claim 1, when the computer program is executed by the processor.

16. A processing circuit comprising a processor and a memory, the memory storing program code instructions of a computer program for executing the process according to claim 12, when the computer program is executed by the processor.

17. The process according to claim 1 wherein the assistance action is an action for assistance using at least one of the services.

18. The process according to claim 12 wherein the at least one assistance action is an action for assistance using at least one second service.

19. The process according to claim 12, wherein the requests sent comprise at least one among the following requests:
at least one request for assistance accessing at least one of the at least two services;
at least one access request to at least one of the at least two services comprising an incorrect password;
at least one access password reset request to at least one of the at least two services;
at least one phone call;
at least one phone call to at least one voice assistance service about at least one of the at least two services.

20. The terminal according to claim 13 where the assistance action is an action for assistance using at least one second service.

21. The process according to claim 18, wherein the requests sent comprise at least one among the following requests:
at least one request for assistance accessing at least one of the at least two services;
at least one access request to at least one of the at least two services comprising an incorrect password;
at least one access password reset request to at least one of the at least two services;
at least one phone call;
at least one phone call to at least one voice assistance service about at least one of the at least two services.
